(19) United States
(12) Patent Application Publication
(10) Pub. No.: US 2013/0293613 A1
(43) Pub. Date: Nov. 7, 2013

(54) SUPERIMPOSING IMAGES ON TRANSLUCENT MEDIA

(71) Applicant: Dan BEREL, Herzliya (IL)

(72) Inventor: Dan BEREL, Herzliya (IL)

(21) Appl. No.: 13/869,185

(22) Filed: Apr. 24, 2013

(30) Foreign Application Priority Data
May 1, 2012 (IL) 219813

(51) Int. Cl. B41J 11/00

(52) U.S. Cl. CPC B41J 11/008
USPC 347/14

(57) ABSTRACT

An inkjet printer for printing onto a media comprising a print-table, a carriage that reciprocates along a track over the print table carrying an array of print-heads and a computer for controlling the reciprocation of the carriage and the jetting of the print heads and further comprising at least a first lamp for backlighting the media and a first camera positioned over the lamp, such that a registration mark on a second face of the media is imaged by the camera as superimposed on a registration mark on the first face of the media.

### FIELD OF THE INVENTION

The present invention relates to methods and systems for superimposing images on a translucent medium, particularly but not exclusively large images printed on wide format printers.

### BACKGROUND OF THE INVENTION

Wide-format printers may be used for printing large images, such as those displayed on roadside billboards, signs, backdrops for conference stands, and the like. For some such applications, the image may be required to be illuminated by natural light reflected from the front by day, and artificially illuminated by night, sometimes from the rear, by backlighting the image. When lit from the rear, light is projected through the medium, illuminating images printed thereon.

With billboards and the like, that are viewable by reflected daylight by day or are backlit by refraction at night, the same image, when backlit, may appear washed out due to absorption and refraction by the semi-transparent medium on which it is printed. This may be the case whether the image is printed on the front or back of the media. To counteract this effect it has been found useful to print the same image twice; a first time on the front and a carefully aligned second (mirror) image on the back, thereby providing two layers of image pigments to be viewed when backlit, providing stronger spectral components. A similar effect may be achieved by printing an image on one side, covering it with a translucent white all over print, and then printing an identical image over the white all over print, such that the second image is carefully aligned with and superimposed over the first image, thereby once again providing two layers.

It will be appreciated that the second technique may have both images printed on the front or on the back.

To achieve sharp, clear backlit images, it is critical that the two superimposed images are accurately aligned. When printing onto polymer films, particularly when printing wide images, it is very difficult to achieve and maintain such alignment, particularly over elongated images and long print runs. Particularly when the medium is flexible and viscoelastic, it may be prone to wrinkling and plastic deformation, particularly when printing exceptionally long images or print runs of multiple copies.

Misalignment of the two images can adversely affect the quality of the image as viewed when backlit, and may result in blurring or other aberrations. For large images viewed from a distance, such as hoardings and the like, the two images are typically aligned to within an accuracy of at least 1 mm for acceptable results.

Manual alignment is labor intensive, and automatic alignment systems for aligning stacks of flat media or roll-stock tend to draft during long print runs, so achieving and maintaining appropriate alignment is difficult, particularly with long print runs.

There is a need for systems and methods of detection and subsequent correction of alignment of the medium, and the present invention addresses this need.

### SUMMARY OF THE INVENTION

A first aspect is directed to providing an inkjet printer for printing onto a media comprising a print-table, a carriage that reciprocates along a track over the print table carrying an array of print-heads and a computer for controlling the reciprocation of the carriage and the jetting of the print heads and further comprising at least a first lamp for backlighting the media and a first camera positioned aligned with the lamp, such that a registration mark on a second face of the media is imaged by the camera as superimposed on a registration mark on the first face of the media.

In some embodiments, the first camera is fixed with respect to the print table.

In some embodiments, the first camera is fixed towards the left side of the print table and a second camera is fixed towards the right side of the print table.

In some embodiments, a second lamp is positioned under the media opposite the second camera.

In some embodiments, the first camera is fixed with respect to the carriage.

In some embodiments, the first lamp is a strip lamp that spans the print table.

The first lamp may be a fluorescent strip.

In various embodiments, the lamp and camera are configured such that the lamp is positioned under the media and the camera is positioned over the media. In other embodiments, the lamp is positioned over the media and the camera is positioned under the media. In yet other embodiments, the lamp and camera are both positioned under the media. In some embodiments, the lamp comprises LEDs positioned around the camera.

In some embodiments, the first registration mark comprises a cross and the second registration mark comprises an array of rectangular blocks.

In other embodiments, the first registration mark comprises an array of rectangular blocks and the second registration mark comprises a cross.

In some embodiments, the print table is at least 3 m wide.

In some embodiments, the print table is at least 5 m wide.

In some embodiments, the printer is selected from the group comprising flat bed printers, roll to roll printers and printers capable of printing both flat bed and roll to roll.

A second aspect of the invention is directed to providing a method of aligning a second image superimposed on a first image comprising the steps of: printing at least one first registration mark in one or both side margins of a medium in a first print run; either turning the medium over, or overprinting the first image with white; printing at least one second registration mark in one or both margins of a second print run; backlighting the at least one first and at least one second registration marks through the medium; capturing at least one image of first and second superimposed registration marks using a camera positioned over the medium; analyzing the image of the first and second superimposed registration marks; applying one or more transformations to the images of the second print run, and printing the second print run.

In some embodiments, the first print run is printed on one face of the medium and the second print run is printed on an opposite face of the medium.

In some embodiments, the at least one transformation is applied from the group consisting of: (i) lateral inversion; (ii) shifting in a direction along the media; (iii) shifting in a direction across the media, and (iv) rotating.

In some embodiments, the printing comprises inkjet printing.

In some embodiments, registration marks are periodically imaged along one margin and adjustments are made periodically.

In some embodiments, the adjustments consist of missing rows of pixels and printing double rows of pixels.

A thirds aspect of the invention is directed to a retrofit for retrofitting an inkjet printer to enable alignment of superimposed images, for printing onto media, the printer comprising a print-table, a carriage that reciprocates along a track over the print table carrying an array of print-heads and a computer for controlling the reciprocation of the carriage and the jetting of the print heads and the retrofit comprising at least a first lamp for backlighting the media and a first camera aligned with the lamp, such that a registration mark on a second face of the media is imaged by the camera as superimposed on a registration mark on the first face of the media.

### BRIEF DESCRIPTION OF THE FIGURES

For a better understanding of the invention and to show how it may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention; the description taken with the drawings making apparent to those skilled in the art how the several forms of the invention may be embodied in practice.

In the accompanying drawings:

FIG. 1 is a schematic plan view of a planar medium printed with an image and showing registration marks in the margins (not to scale);

FIG. 2 is a schematic front elevation view of a wide format printer in accordance with one configuration;

FIG. 3 is a schematic front elevation view of a wide format printer in accordance with a second configuration;

FIG. 4 shows a first registration mark;

FIG. 5 shows a second registration mark;

FIG. 6 shows the first registration mark superimposed over the second registration mark in correct alignment;

FIG. 7 shows the first and second registration marks misaligned in the slow scan or feed direction along the image;

FIG. 8 shows the first and second registration marks misaligned in the fast scan or rastering direction;

FIG. 9 shows the first and second registration marks misaligned by a rotation, with the second registration mark angled with respect to the first registration mark, and

FIG. 10 is a flow chart illustrating a generalized method of the invention.

### DESCRIPTION OF EMBODIMENTS

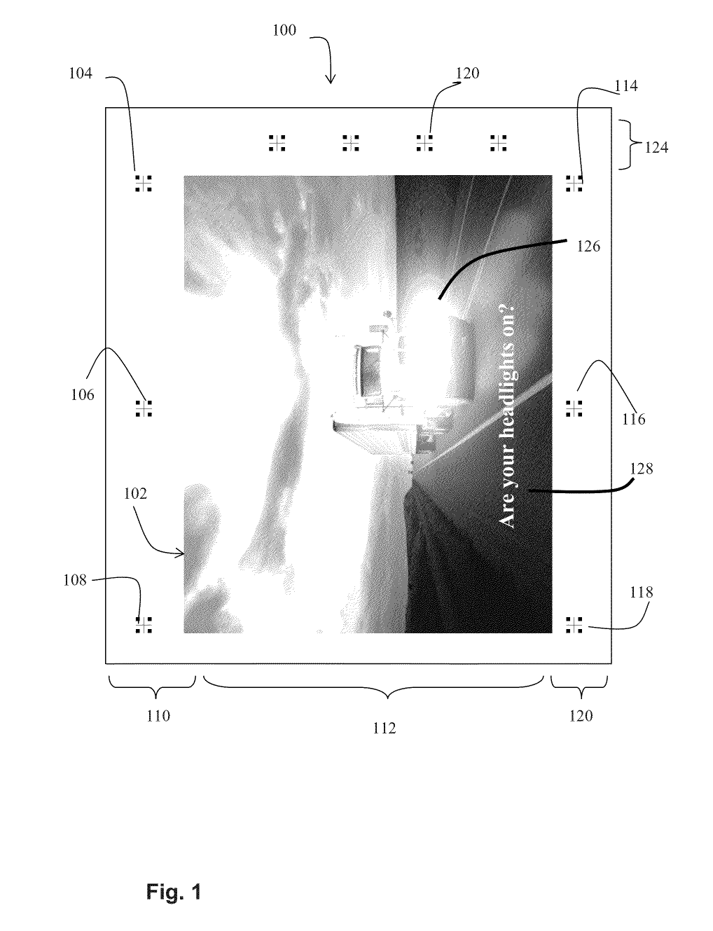

With reference to FIG. 1, a schematic plan view of a planar medium 100 printed with an image 102 in a central print region 112 and showing a first series of registration marks 104, 106, 108 in a first margin 110 of the print region, and a second series of registration marks 114, 116, 118 in a second margin 120 of the central print region, (not to scale). Also shown, are registration marks 122 in a top margin 124.

By way of example, the image 102 depicted, is of a lorry with lit up headlamps 126 and a message “Are your lights on” 128.

It may be appreciated that such an image could be printed on a semitransparent medium 100 and displayed on a hoarding. Due to the semi opaqueness of the medium 100, such an image may be viewed in ambient light reflected off the front face by day, but due to the semitransparent or translucent characteristics of the medium 100, it may be backlit and the image displayed may be viewed by night.

Such images, when simply printed in a single layer may appear ‘washed out’ with a reduction in contrast when backlit. To enable the image to be clearly defined, when backlit, it has proven useful to superimpose two similar images, one on top of the other. In one technique, a laterally inverted, i.e. mirror image of the front image as shown is printed on the back. In a second technique, a first image is printed, and a second image is printed thereover. Provided the superimposed images are accurately aligned, printing a double image enables the image 102 to appear adequately defined whether viewed by day light or when backlit at night.

Furthermore, the rear image need not be identical to the front image. For example, the illuminated headlights 126 and the message “Are your lights on” 128 may be printed on the rear image only, such that these are displayed only when backlit.

The accuracy of the alignment of the front and back images is situation specific, but as a rule of thumb, for billboard hoardings, an accuracy of about ±1 mm is typically adequate.

To enable such accurate alignment, registration marks may be used.

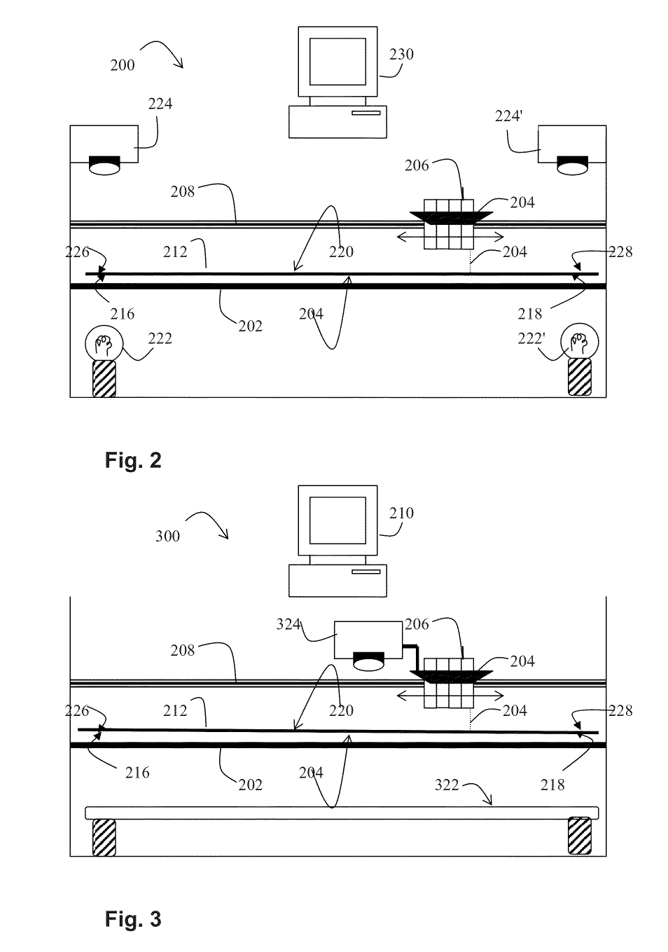

With reference to FIG. 2, a schematic front view of a wide format inkjet printer 200 is shown. Wide format printer 200 consists of a print-table 202 and a carriage 204 carrying an array of print-heads 206 that reciprocates along a track 208. A computer 210 instructs the carriage 204 to move left and right along the track 208 and instructs the array of print-heads 206 to jet ink 210 onto media 212 thereunder.

A feeding mechanism as known (not shown) advances the media 212 in the slow scan direction (out of the page).

A first image may be printed on a first side 214 of the media 212, and a first registration mark 216 may be printed in one margin and another registration mark 218 may be printed in a second margin.

The media 212 is then turned over and a second, laterally inverted image is printed on the second side 220.

When printing roll to roll, the media 212 may be reversed automatically by a system of rollers. With flat bed printing, the media 212 may be manually turned over.

In both instances, it is difficult to ensure accurate alignment and a slight shift of even a millimeter or so may produce blurring or ghosting when the resulting double layer image is illuminated from behind.

It is difficult to accurately align large and unwieldy media 212. Where forwarding mechanisms use pick up rollers, the varying diameter as more material is picked up may cause a shift. Slipping between media 212 and the print table 202 thereunder may cause such shifts. Where alignment is attempted manually, the results are generally time-consuming and unsatisfactory.

Instead of aligning the medium 212 with the printer 200, embodiments align one or more registration marks 226 in the margin of the second image on the second side 220 with one or more registration marks 216 in the margin of the first image on the first side 214. To accomplish this, the semitransparent media 212 is illuminated from below via a lamp 222 provided for that purpose, and the superimposed first and second registration marks 216, 226 are imaged using a camera 224 aligned with the lamp 222, and positioned over the media 212.

In some embodiments, the lamp 222 and camera 224 are fixed to the printer 200 at one end of the rastering direction. In other embodiments, a second lamp 222′ and second camera 224′ are provided at the second side.

Viewing with one pair of registration marks 216, 226 in one margin provides one point of reference for aligning the second image on the second face 220 of the media 212 with the first image on the first face 214 of the image. This may be sufficient, particularly when printing on rigid media. In some embodiments, a second lamp 222′ and camera 224′ are provided for illuminating and imaging a second pair of superimposed registration marks 218, 228 in the second margin. By checking alignment at two points of reference (in the two side margins 110, 120 (FIG. 1) of the image 102 (FIG. 1) being printed, it will be appreciated that more accurate alignment is achievable.

The first image is printed together with registration mark(s) 216 (218). The media 212 is turned over and (a) second (set of) registration mark(s) is printed. The relative position of the second registration mark(s) 226 (228) with respect to the first registration mark(s) 216 (218) may be used to apply corrections to the instructions and data sent to the carriage 204 and array of print heads 206 to adjust the position of the jetting of the ink 210 to adjust the position of the image to be printed.

With reference to FIG. 3, a printer 300 is shown. Printer 300 consists of a print-table 202 and a carriage 204 carrying an array of print-heads 206 that reciprocates along a track 208. Printer 300 is similar to wide format printer 200, mutatis mutantis, however, in printer 300, a camera 324 is mounted on the carriage 204 and reciprocates over the print table 202. Camera 324 may usefully be positioned in front of the print-heads 206.

The lamp 322 may be a fluorescent strip, for illuminating registration marks at any point across the width of the print table 202, so that wider or narrower media may be printed, and an array of images may be printed in parallel, with registration marks in the margins of some or all parallel images in the array.

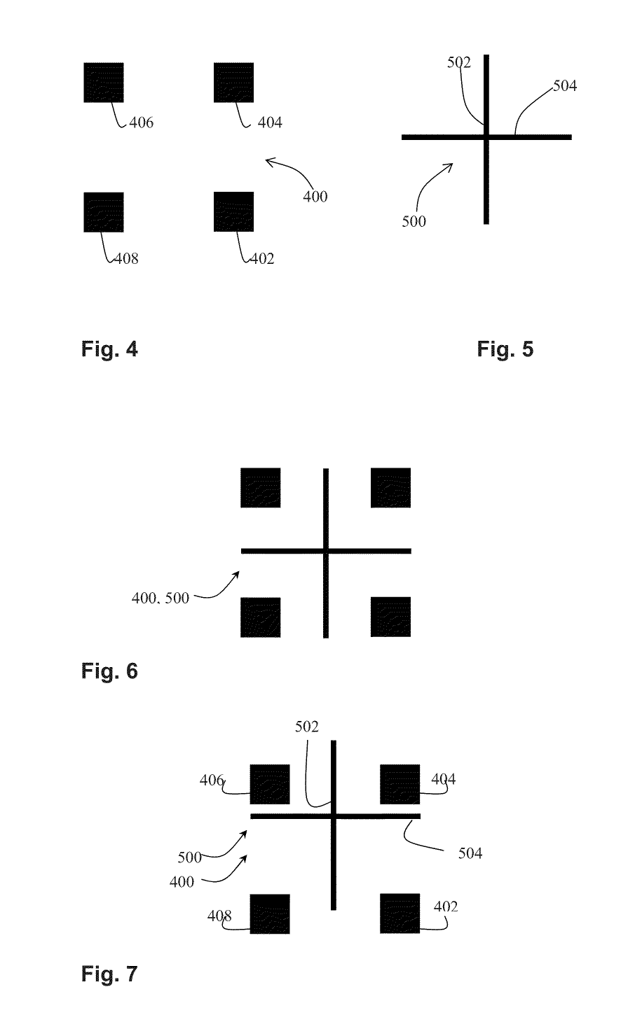

With reference to FIG. 4, and by way of illustration only, in one embodiment, a first registration mark 400 consists of an array of four rectangles 402, 404, 406, 408.

With reference to FIG. 5, and by way of illustration only, in one embodiment, a second registration mark 500 consists of cross shape composed of the two perpendicular bisectors denoted 502, 504.

As shown in FIG. 6, when alignment is perfect, the second registration mark 500 is perfectly centered and congruent with respect to the first registration mark 400, such that first bisector 502 lies midway between squares 404 and 406 and midway between squares 402 and 408, and second bisector 504 lies midway between pair of squares 402 and 404 and midway between pair of squares 406 and 408.

Examples of imperfect alignments are shown in FIGS. 7-9.

With reference to FIG. 7, the second registration mark 500 has been shifted in the direction along the feed, and bisector 504 is too close to squares 404, 406.

Such a shift may be the result of slippage of the advancing mechanism, for example.

To compensate for this type of misalignment, the image to be printed could be transformed by a shift in slow scan direction. Referring back to FIG. 1, where a series of registration marks 104, 106, 108 is made along a margin 110, corrections may be made on the fly; the printer 200 could for example be programmed to repeat one or more rows of pixels across the medium 212. Similarly, a shift in the opposing direction could be corrected for by missing a row of pixels.

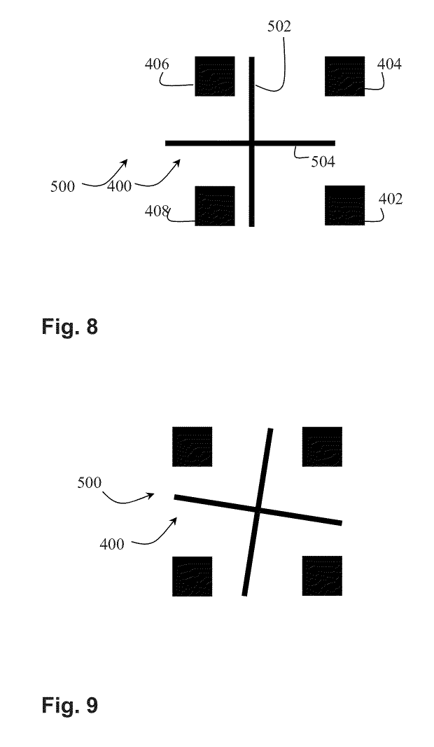

With reference to FIG. 8, the second registration mark 500 is shifted to the side with respect to the first registration mark 400, so bisector 502 is too close to squares 406, 408. To compensate for a leftwards displacement or misalignment indicated in FIG. 8, the position of the second image may be shifted rightwards. Similarly, to compensate for a rightwards displacement or misalignment, the position of the second image may be shifted leftwards. Where one registration mark is used, a single sideways transformation of the image to be printed is made. Where a number of registration marks are provided along a media, e.g. registration marks 104, 106, 108, lines of pixels may be added or deleted or a whole section may be shifted by one or more rows of pixels in the rastering direction, on the fly.

With reference to FIG. 9, the second registration mark 500 may be rotated with respect to the first registration mark 400. A clockwise rotation of angle −θ (−theta) in registration mark, indicating a shift in the medium may be corrected by a counterclockwise rotation of angle θ (theta) applied to the image or a section of it.

Although media 212 illustrated in FIGS. 2 and 3 is shown printed on both faces, it will be appreciated that similar corrections may be used to align a second image printed over a first image.

It is a feature of digital printing, that essentially an image comprises a two dimensional array of pixels. This two dimensional array of pixels may be laterally inverted, shifted or rotated by applying an appropriate matrix transformation.

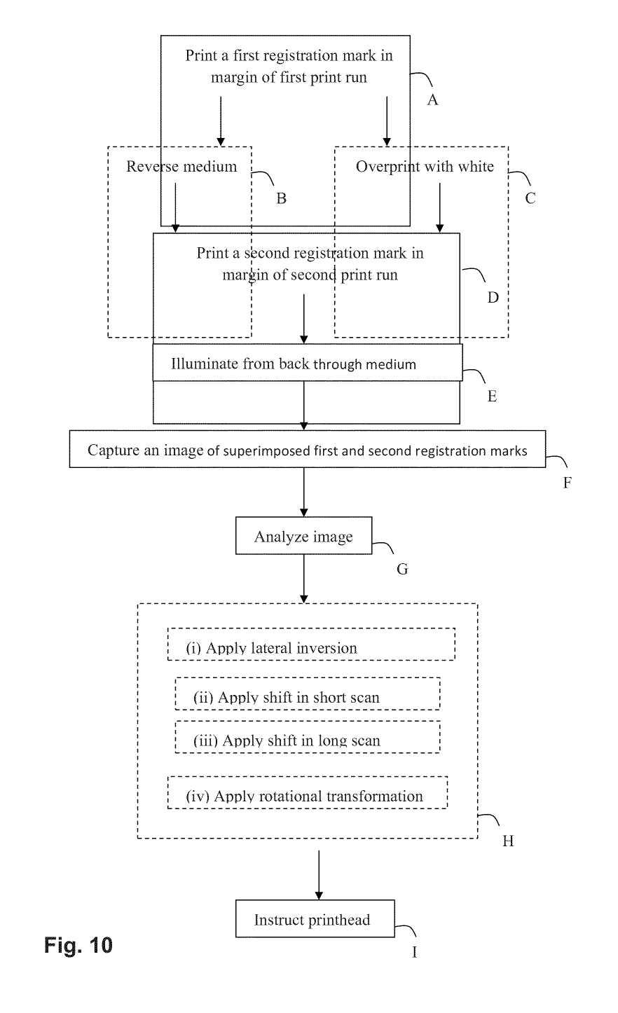

With reference to FIG. 10 and referring back to FIG. 2, a method for aligning a second print run with a first print run is now described.

One or more first registration marks 216 (218) are printed in one or both margins of a first print run—step (A). Either the medium 212 is reversed—step (B) or the first print run is overprinted with white—step (C). One or more second registration marks 226 (228) are printed in one or both margins of a second print run—step (D). The first and second one or more registration marks are illuminated through the media by lamp 222 (222′, 232). An image of first and second superimposed registration marks is captured—step F using camera 224 (224′, 234) positioned over the media 212. The image of the first and second superimposed registration marks is analyzed—step G, using the computer 210 controlling the printer 200, for example. One or more transformations are applied to the image to be printed. The appropriate transformations are well understood by persons of the art. Essentially, where the second image is printed on the other side, the (second) image to be printed is laterally inverted (i). Where the position of the second registration mark 500 relative to the first registration mark 400 indicates a shift in the slow scan direction, i.e. along the media, as shown in FIG. 6, for example, the second image to be printed is shifted to compensate (ii).

Where the position of the second registration mark 500 relative to the first registration mark 400 indicates a shift in the fast scan direction, i.e. across the media, as shown in FIG. 6, for example, the second image to be printed is shifted in the opposite direction to compensate (iii). Thus, a shift of second registration mark 500 to the right with respect to first registration mark is compensated for by shifting the image to be printed to the left, and a shift of second registration mark 500 to the left with respect to first registration mark, is compensated for by shifting the image to the right. The image shifts may be accomplished by matrix transformations, as known.

Where the position of the second registration mark 500 relative to the first registration mark 400 indicates a rotation, such as that shown in FIG. 9, the second image to be printed is rotated in the opposite direction to compensate (iv). Thus, a positive rotation of the second registration mark 500 with respect to first registration mark 400 may be compensated for by a negative rotation of the image to be printed.

The image rotation may be accomplished by matrix transformations, as known.

It will be appreciated that rotations are best noted by printing more than one pair of registration marks, such as on both margins, or in different positions along a margin, since viewing a slight rotation shift between two superimposed but misaligned registration marks is not easy, but the error increases with distance, so at a different pair of registration marks, will generally be noticeable.

Referring back to FIG. 1, where the medium is rigid and the advancing means is sufficiently accurate, only one pair of registration marks 104 is required.

Generally, for billboard hoardings, for example, tolerances of ±1 mm are sufficient. Using the method outlined, tolerances an order of magnitude higher may be achieved.

Since the medium could shift slightly, and with flexible media, such as generally supplied on roll stock, could wrinkle or deform plastically, or become wavy, etc., preferably a registration mark 104, 114, is applied in each side margin 110, 120.

With long pieces of media, the advancing means may advance the media in the slow scan direction at different speeds when printing first image on first face and when printing second image on second face. Furthermore, the advancing in slow scan speed may not be totally steady, or the medium may slip on the roller, or develop waves, with waves across the width of the print table,

Preferably the first and second series of registration marks include additional registration marks 106, 108 (116, 118) along the margins 110 (120) periodically along the image 102, so that periodic adjustments may be made, which is easily accomplished where the image is a pixilated or digital image such as when printed using an inkjet printer.

Thus to maintain accurate alignment in extensive images, periodic registration marks, may be used to make periodic corrections, on the fly, in real time.

It has been found that using the approach described hereinabove, alignments of better than ±0.1 mm may be attained when printing wide (i.e. 1 m to 3 m wide images, and even when printing 5 m or 10 m wide images on flexible substrates.

It is appreciated that although described above with respect to an inkjet printer, where a second image is aligned with a first image, the method of alignment is applicable to aligning any pixilated array to be deposited pixel by pixel, with a previously defined image. Indeed, the system may be applied to accurately position an array of pixels with a misaligned medium.

In accordance with an embodiment of the invention there is provided a retrofit for retrofitting an inkjet printer to enable alignment of superimposed images, for printing onto media, the printer comprising a print-table, a carriage that reciprocates along a track over the print table carrying an array of print-heads and a computer for controlling the reciprocation of the carriage and the jetting of the print heads and the retrofit comprising at least a first lamp for backlighting the media and a first camera aligned with the lamp, such that a registration mark on a second face of the media is imaged by the camera as superimposed on a registration mark on the first face of the media.

Although described hereinabove with the lamp positioned under the medium and the camera positioned over the medium, it will be appreciated that the alignment of two superimposed registration images may be monitored by a camera positioned under the media and a lamp positioned over the media. Indeed, a lamp and camera both positioned under the media, such as a camera with surrounding illumination may be able to view the superimposed registration marks by reflection; perhaps where the lamp consists of a light emitting diode LED, or better, a series of LEDS around the camera.

Thus persons skilled in the art will appreciate that the present invention is not limited to what has been particularly shown and described hereinabove. Rather the scope of the present invention is defined by the appended claims and includes both combinations and sub combinations of the various features described hereinabove as well as variations and modifications thereof, which would occur to persons skilled in the art upon reading the foregoing description.

In the claims, the word “comprise”, and variations thereof such as “comprises”, “comprising” and the like indicate that the components listed are included, but not generally to the exclusion of other components.

I claim:

1. An inkjet printer for printing onto a media comprising a print-table, a carriage that reciprocates along a track over the print table carrying an array of print-heads and a computer for controlling the reciprocation of the carriage and the jetting of the print heads and further comprising at least a first lamp for backlighting the media and a first camera aligned with the lamp, such that a registration mark on a second face of the media is imaged by the camera as superimposed on a registration mark on the first face of the media.

2. The ink jet printer of claim 1, wherein the first camera is fixed with respect to the print table.

3. The ink jet printer of claim 1, wherein the first camera is fixed towards left side of the print table and a second camera is fixed towards right side of the print table.

4. The ink jet printer of claim 3, wherein a second lamp is aligned with the second camera.

5. The ink jet printer of claim 1, wherein the first camera is fixed with respect to the carriage.

6. The ink jet printer of claim 5, wherein the first lamp is a strip lamp that spans the print table.

7. The ink jet printer of claim 6, wherein the first lamp is a fluorescent strip.

8. The ink jet printer of claim 6, wherein the lamp and camera are configured such that either:
the lamp is positioned under the media and the camera is positioned over the media;
or the lamp is positioned over the media and the camera is positioned under the media, or the lamp and camera are both positioned under the media.

9. The ink jet printer of claim 1, wherein the first registration mark comprises a cross and the second registration mark comprises an array of rectangular blocks.

10. The ink jet printer of claim 1, wherein the first registration mark comprises an array of rectangular blocks and the second registration mark comprises a cross.

11. The ink jet printer of claim 1, wherein the print table is at least 3 m wide.

12. The ink jet printer of claim 1, wherein the print table is at least 5 m wide.

13. The ink jet printer of claim 1, wherein the printer is selected from the group comprising flat bed printers, roll to roll printers and printers capable of printing both flat bed and roll to roll.

14. A method of aligning a second image superimposed on a first image comprising the steps of:
A. printing at least one first registration mark in one or both side margins of a medium in a first print run;
B. Either turning the medium over, or
C. Overprinting the first image with white;
D. Printing at least one second registration mark in one or both margins of a second print run;
E. Backlighting the at least one first and at least one second registration marks through the medium;
F. Capturing at least one image of first and second superimposed registration marks using a camera positioned over the medium;
G. Analyzing the image of the first and second superimposed registration marks;
H. Applying one or more transformations to the images of the second print run, and
I. Printing the second print run.

15. The method of claim 14, wherein the first print run is printed on one face of the medium and the second print run is printed on an opposite face of the medium.

16. The method of claim 14, wherein at least one transformation is applied from the group consisting of:
lateral inversion;
(ii) shifting in a direction along the media;
(iii) shifting in a direction across the media, and
(iv) rotating.

17. The method of claim 14, wherein the printing comprises inkjet printing.

18. The method of claim 14, wherein registration marks are periodically imaged along one margin and adjustments are made periodically.

19. The method of claim 18, wherein the adjustments consist of missing rows of pixels and printing double rows of pixels.

20. A retrofit for retrofitting an inkjet printer to enable alignment of superimposed images, for printing onto media, the printer comprising a print-table, a carriage that reciprocates along a track over the print table carrying an array of print-heads and a computer for controlling the reciprocation of the carriage and the jetting of the print heads and the retrofit comprising at least a first lamp for backlighting the media and a first camera aligned with the lamp, such that a registration mark on a second face of the media is imaged by the camera as superimposed on a registration mark on the first face of the media.
